(19) United States
(12) Patent Application Publication
(10) Pub. No.: US 2010/0241559 A1
(43) Pub. Date: Sep. 23, 2010

(54) FINANCIAL SOCIAL NETWORKING

(75) Inventors: Sean M. O'Connor, Scituate, MA (US); William F. Borowski, Millbury, MA (US); Kazi M. Ariff, Quincy, MA (US); Carol A. Smith, Edgartown, MA (US); Judith M. Anderson, East Walpole, MA (US); Steven K. Hayes, Bemus Point, NY (US); Thomas D. Kelley, Hingham, MA (US); Neal G. Wolfson, Lexington, MA (US); Susan S. Thomas, Gastonia, NC (US); Russell W. Tipper, Boston, MA (US); Jeffrey P. Judd, Boston, MA (US); William J. Aheron, Charlottte, NC (US); Yicong Li, Lexington, MA (US); Shane A. Johnson, Charlotte, NC (US); James P. Kirkman, Acton, MA (US); Jeffrey H. Bierer, Charlotte, NC (US)

Correspondence Address: Weiss & Arons, LLP, 1540 Route 202, Suite 8, Pomona, NY, 10970, US

(73) Assignee: Bank of America, Charlotte, NC (US)

(21) Appl. No.: 12/407,831

(22) Filed: Mar. 20, 2009

(51) Int. Cl. G06Q 40/00; G06F 3/048; G06Q 99/00; G06Q 20/00

(52) U.S. Cl. 705/39; 715/760; 705/35; 715/810

(57) ABSTRACT

Apparatus and methods for providing an online financial social network service to a user. The method may include storing in a computer information about a financial goal of a first user. The method may additionally include receiving instructions to present a display reflecting the stored financial goal information. The method may also include authenticating a second user to access the first user online financial social network account.

### FIELD OF TECHNOLOGY

Aspects of the disclosure relate to systems and methods for offering a social networking service. Specifically, the invention relates to offering an online social network account.

### BACKGROUND OF THE INVENTION

Some networks provide systems and methods for displaying financial goals. In such systems and methods, the user needs to establish a social network in order to share his financial goals with his friends. This is not desirable if the user wants to share his financial goals with friends in an existing social network.

Therefore, it would be desirable to provide systems and methods wherein a user is able to share his financial goals in an existing social network.

Additionally, some networks provide systems and methods for representing a financial goal by displaying the monies involved. This is not desirable if a user wants to share his financial aspirations in a safe and private manner.

Therefore, it would be desirable to provide systems and methods wherein a user can share his financial goals in a private and safe way.

### SUMMARY OF THE INVENTION

A method for providing an online financial social network account is disclosed. The method may use an electronic information processing platform. The method may include storing, in a computer memory, information about a financial goal of a first user. The method may additionally include receiving instructions to change a display associated with a first user online social network account to reflect the stored financial goal information. The method may also include modifying the first user online social network account to reflect the stored financial goal information. The method may further include authenticating a second user to access the first user financial social network account.

### BRIEF DESCRIPTION OF THE DRAWINGS

The objects and advantages of the invention will be apparent upon consideration of the following detailed description, taken in conjunction with the accompanying drawings, in which like reference characters refer to like parts throughout, and in which:

FIG. 1 is a schematic diagram of apparatus that may be used in accordance with the principles of the invention;

FIG. 2 shows an illustrative flow diagram of a process for initiating a financial social network account;

FIG. 3 shows an illustrative flow diagram of a process for modifying an online social network account to include a financial social network account;

FIG. 4 shows an illustrative flow diagram of a financial social network account process;

FIG. 5 shows an illustrative flow diagram of a financial social network account process; and

FIG. 6 shows an illustrative flow diagram of a financial social network account process.

### DETAILED DESCRIPTION OF THE INVENTION

In systems and methods according to the invention, a system may be created that provides a financial social network account, i.e., a social network account that relates directly to financial matters. The method may allow a first user to create a financial social network account. The method may further allow the first user to display information relating to a financial goal.

It should be noted that more than one user may create the financial social network account. For example a husband and wife, two friends, an organization, school, charity, or any other group that shares a financial goal may create a financial social network account according to the systems and methods of the invention.

It should additionally be noted that the financial social network account may be part of an online social network account. In this embodiment, information pertaining to the financial social network account may be downloaded into the online social network account. In addition, a social network account or any other online account or web page may support a link to the financial social network account. In one embodiment, the financial social network account may be part of an online financial institution. The financial social network account may support some or all of generic social networking operations.

In the embodiment wherein the financial social network account is part of a social network account, the financial social network account information may be displayed on the first user social network account homepage or in any other desirable area of the first user social network account. Additionally, a selection performed on the first user social network account may cause first user financial social network account information to be displayed.

In the embodiment of a group of first users (who may be referred to alternatively as “group users”), the financial social network account may appear on each group user social network account. The financial social network account may be the same in each group user social network account. Alternatively, the financial social network account may differ in each group user social network account.

The financial social network account may support a link to a financial institution online banking website. This link may enable the financial social network account with banking capabilities. The financial social network account may also support a link to a first user online bank account. The first user may select to authorize the financial institution to support a link to the first user online bank account.

In the systems and methods of the invention, the first user may provide information pertaining to one or more financial goals. The maximum number of financial goals may be predetermined.

The financial goal of the first user may be a home, vacation, vehicle, or any other desirable financial goal. The financial goal of the first user may additionally be accumulating a desired amount of funds in a savings account, investment, high rate CD, retirement plan, 529 account, tuition fund, or in any other suitable location.

In one embodiment of the invention, the financial goal(s) of the first user may be represented visually by one or more pictures or images of the user's choosing. The picture/image may be selected from stock photos provided by a system. The picture/image may additionally be “uploadable”—i.e., an electronic platform may be provided whereby a user can upload his own pictures.

In the systems and methods of the invention, the first user may provide information pertaining to the financial goal. The first user may additionally provide information pertaining to a predetermined program towards attaining the financial goal. The first user may provide information pertaining to investment strategies, account interest rates, expected completion times, progress reports, or any other information pertaining to the predetermined program and progress towards the financial goal. This information may be provided by responding to an electronic questionnaire, selecting predetermined options, or through any other suitable method of communication.

In the embodiment wherein the systems and methods of the invention allow for group users, one or more group users may be authorized to provide some or all of the information pertaining to the financial goal. In this embodiment, a modification of the financial goal may or may not cause a modification in the financial social network account of every group user.

In one embodiment of the systems and methods of the invention, a group raising funds for charity may desire to create a financial social network account which reflects the goals and progress of the group. The financial social network account may appear on each group user social network account. Each group user may be authorized to personalize the financial social network account displayed in their social network account, but only one group user may have administrative authorization to provide, for example, information pertaining to the progress of the group towards the charitable goal. Progress of the group towards the charitable goal may preferably be reflected in every group user financial social network account.

The systems and methods of the invention may include displaying information pertaining to the financial goal of the first user. The information pertaining to the financial goal of the first user may be displayed in the first user financial social network account. A visual representation of the financial goal may be displayed. This representation may be pre-determined, selected from a list of options, or customized by the first user. A video, song, link, or any other media and/or information desired by the first user may be used towards representing the financial goal and the progress towards and/or achievement of the financial goal.

The systems and methods of the invention may further comprise displaying information obtained from the first user. This information may relate to the predetermined program towards achieving the financial goal. A timetable representing the expected progress of the first user towards the financial goal may be used. Additionally, a date for the attainment of the financial goal may be displayed. The first user may additionally select to display comments on the first user financial social network account. The comments may have been received from the first user, second user, a financial advisor, banking representative, chosen from a list, or incorporated from any other desirable information.

The first user may progress towards the financial goal by depositing funds into financial institution accounts. The accounts may be one or more savings accounts, investment accounts, a combination of accounts, or any other suitable accounts. The first user may additionally progress towards the financial goal through exercising stock options, receiving donations, fund raising, collecting coupons, or any other means of acquiring funds.

The systems and methods of the invention may include displaying the progression of the first user towards the financial goal. The progress of the first user towards the financial goal may be represented using a percent, a graph, a chart, a picture, a numerical value, or any other desirable data and/or representative data.

The display of the progression of the first user towards the financial goal may additionally include a history log. The history log may include the date and/or time of progressions towards the financial goal. The history log may also state who contributed towards the financial goal. The history log may additionally include posted comments relating to the progression of the first user towards the financial goal.

In the embodiment wherein the financial social network account supports a link to a financial institution, the first user may be a customer of the financial institution. In this embodiment, the progression of the first user towards the financial goal may be downloaded and updated from the relevant first user online bank accounts. This service may be selected by the first user.

The progress of the first user towards the financial goal may be updated weekly, monthly, or at any other pre-determined time. Alternatively, the progress of the first user towards the financial goal may be updated upon modification of the relevant first user online bank accounts.

When the first user financial goal is reached, the financial social network account may be modified. This modification may be selected or predetermined. Additionally, other users may be notified of the modified first user status.

The systems and methods of the invention may include providing the first user with a method to personalize his financial social network account. This personalization may include personalizing the title of the financial social network account, posting pictures, articles, comment, links, or any other desirable electronic personalization in the financial social network account.

In the systems and methods of the invention, one or more second users may be authorized to view a first user's financial social network account. The second user may be a friend, parent, spouse, financial advisor, bank representative, or any other second user designated by the first user.

It should be noted that the systems and methods of the invention may include a second user that may post some or all of the first user financial social network account information on a second user social network account. For example, a wife may post her husband's financial goals on her social network account. This privilege may require authentication from the first user.

In the embodiment wherein the financial social network account is incorporated into a social network account, a second user who is authorized to view the first user social network account may be automatically authorized to view the first user financial social network account. Alternatively, the first user may instead select from his existing social network ‘friends’ those that he desires to be authorized to access his financial social network account.

In yet another embodiment, the first user may authorize a second user to view his account, wherein the second user may not be authorized to view the first user social network account. In such embodiments, the first user may transmit to the second user a link or other suitable piece of information pertaining to the first user financial social network account. The link sent by the first user may allow the second user to view and/or participate in the first user financial social network account despite not being a member of the first user social network.

In the embodiment wherein the systems and methods of the invention include group users, each group user may authorize one or more second users to view his financial social network account.

The authorizations of the second user with respect to the first user financial social network account may be predetermined. Alternatively, the permissions of the second user in the first user financial social network account may be selected by the first user. The permissions of the second user may include posting comments in the first user financial social network account, contributing towards the financial goal, receiving e-mails pertaining to modifications in the financial social network account, viewing part of or all of the financial social network account, or any other permissions desired by the first user. In the embodiment wherein the systems and methods of the invention include multiple second users, they may all be granted equal privileges. Alternatively, the first user may select the privileges of each second user.

In the systems and methods wherein the financial social network account is part of an online financial institution, the first user may invite a second user to participate in his online financial institution account. The second user may or may not be a member of the financial institution and/or financial institution social network.

The second user may be required to authenticate his identity to access his privileges. This authentication may include providing a user name and password, birth date, or any other identifying piece of information.

The second user may be notified when a change occurs in his permissions with respect to the first user financial social network account. The second user may additionally be notified when a modification occurs in the first user financial social network account. This notification may automatically occur after every modification. Alternatively, the notification may occur after specific modifications of the financial social network account. This may be an option selected by the first user. The first user may also be provided with the option of sending an e-mail to select second user/s or to all second users requesting comments or advice pertaining to his financial goal. In the embodiment of group users, each group user may select the second user/s to be authorized to receive notifications pertaining to his account.

In the embodiment wherein the financial social network account is sponsored, created or supported by a financial institution or any other institution, company, organization or network, the first and/or second user may receive one or more e-mails from the supporting media. The e-mail(s) may include information pertaining to the financial social network account. The e-mail(s) may also include information relating to a service, promotion, idea, or any other information the supporting media desires to convey to the first and/or second user.

In the embodiment wherein the financial social network account supports a link to an online financial banking institution or any other financial institution, the first and/or second user may be able to contribute funds towards the first user financial goal. Funds may be contributed towards the first user financial goal using a credit card, debit card, or by providing personal information and subsequently receiving a bill in the mail. Funds may be contributed towards a portion of the financial goal or may be used to pay the financial goal in full.

In the embodiment wherein the second user contributes funds towards the first user financial goal, the second user contribution may be identified on the first user financial social network account message board, progress chart, or any other desirable area. Upon the completion of the second user transaction, a notification may be sent to the first user of the second user transaction. The notification may be personalized by the second user.

The systems and methods of the invention may include one or more methods of communication between the first and second user. Real time chat, electronic sticky notes, a message board log, uploading of information, or any other desired method of communication between the first and second user may be included in the first user financial social network account.

In the embodiment wherein the financial social network account supports a link to a financial institution, the financial institution may be included in some or all of the aforementioned communications with the first user. The first user may or may not be an account holder at the financial institution.

In the aforementioned embodiment, an option may be available to the first user to select a time for an online chat session with a banking representative. In an alternative embodiment, online chat with a banking representative may be supported at substantially all times. The financial institution may be authorized to post comments on the financial social network account. The financial institution may additionally be authorized to post a link to a financial institution webpage on the first user financial social network account. The comments of the financial institution may be pre-determined, personalized, or semi-personalized.

The comments of the financial institution may relate to the financial goal of the first user. The comments of the financial institution may include strategic investment options, long-term planning advice, accounts available to the first user, or any other helpful financial advice. The financial institution comments may additionally include promotions, offers, contests, advertisements, or any other information relating to products and/or services offered by the financial institution.

Additionally, the financial institution may receive information pertaining to the investment habits, financial goals, and predetermined financial plans of the first user.

The aforementioned methods are desirable as they allow a first user to display his financial plans and goals to a network of friends and users. They are desirable at least because they provide a platform for those close to the first user to share their advice and opinions. They are additionally desirable in that advice may be sought from a financial institution. Accordingly, systems and methods according to the invention combine advice from trusted advisors with professional experience.

In the following description of the various embodiments, reference is made to the accompanying drawings, which form a part hereof, and in which is shown by way of illustration various embodiments in which the invention may be practiced. It is to be understood that other embodiments may be utilized and structural and functional modifications may be made without departing from the scope and spirit of the present invention.

As will be appreciated by one of skill in the art upon reading the following disclosure, various aspects described herein may be embodied as a method, a data processing system, or a computer program product. Accordingly, those aspects may take the form of an entirely hardware embodiment, an entirely software embodiment or an embodiment combining software and hardware aspects.

Furthermore, such aspects may take the form of a computer program product stored by one or more computer-readable storage media having computer-readable program code, or instructions, embodied in or on the storage media. Any suitable computer readable storage media may be utilized, including hard disks, CD-ROMs, optical storage devices, magnetic storage devices, and/or any combination thereof. In addition, various signals representing data or events as described herein may be transferred between a source and a destination in the form of electromagnetic waves traveling through signal-conducting media such as metal wires, optical fibers, and/or wireless transmission media (e.g., air and/or space).

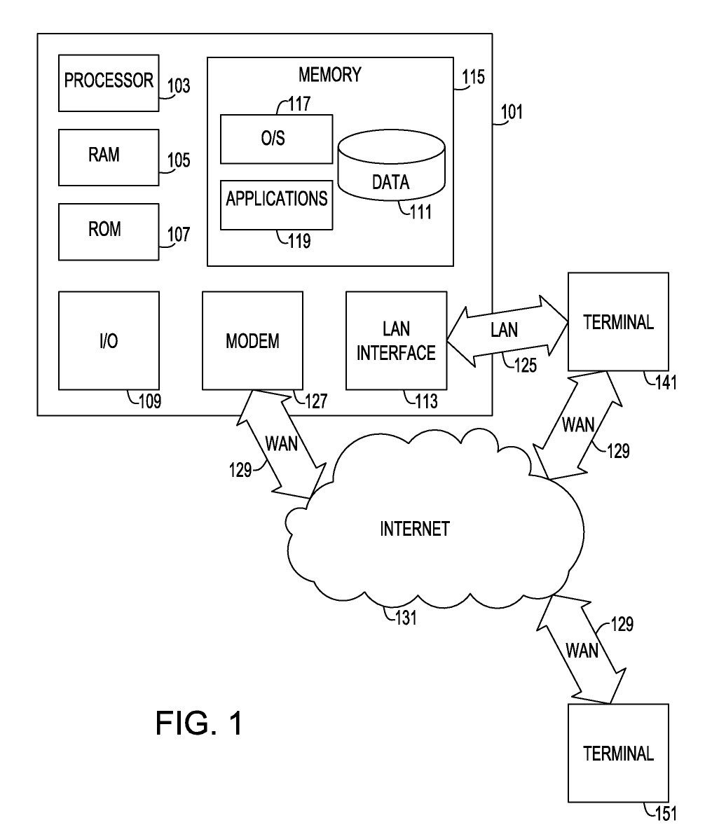

FIG. 1 is a block diagram that illustrates a generic computing device 101 (alternatively referred to herein as a “server”) that may be used according to an illustrative embodiment of the invention. The computer server 101 may have a processor 103 for controlling overall operation of the server and its associated components, including RAM 105, ROM 107, input/output module 109, and memory 125.

Input/output (“I/O”) module 109 may include a microphone, keypad, touch screen, and/or stylus through which a user of device 101 may provide input, and may also include one or more of a speaker for providing audio output and a video display device for providing textual, audiovisual and/or graphical output. Software may be stored within memory 125 and/or storage to provide instructions to processor 103 for enabling server 101 to perform various functions. For example, memory 125 may store software used by server 101, such as an operating system 117, application programs 119, and an associated database 121. Alternatively, some or all of server 101 computer executable instructions may be embodied in hardware or firmware (not shown). As described in detail below, database 121 may provide storage for user information; financial social network information, and/or any other suitable information.

Server 101 may operate in a networked environment supporting connections to one or more remote computers, such as terminals 141 and 151. Terminals 141 and 151 may be personal computers or servers that include many or all of the elements described above relative to server 101. The network connections depicted in FIG. 1 include a local area network (LAN) 125 and a wide area network (WAN) 129, but may also include other networks. When used in a LAN networking environment, computer 101 is connected to LAN 125 through a network interface or adapter 123. When used in a WAN networking environment, server 101 may include a modem 127 or other means for establishing communications over WAN 129, such as Internet 131. It will be appreciated that the network connections shown are illustrative and other means of establishing a communications link between the computers may be used. The existence of any of various well-known protocols such as TCP/IP, Ethernet, FTP, HTTP and the like is presumed, and the system can be operated in a client-server configuration to permit a user to retrieve web pages via the World Wide Web from a web-based server. Any of various conventional web browsers can be used to display and manipulate data on web pages.

Additionally, application program 119, which may be used by server 101, may include computer executable instructions for invoking user functionality related to communication, such as email, short message service (SMS), and voice input and speech recognition applications.

Computing device 101 and/or terminals 141 or 151 may also be mobile terminals including various other components, such as a battery, speaker, and antennas (not shown).

A terminal such as 141 or 151 may be used by an administrator to open, view and process user information and to issue one or more instructions regarding financial social networking. Financial social network account information may be stored in memory 125. The financial social network account information may be processed by an application such as one of applications 119.

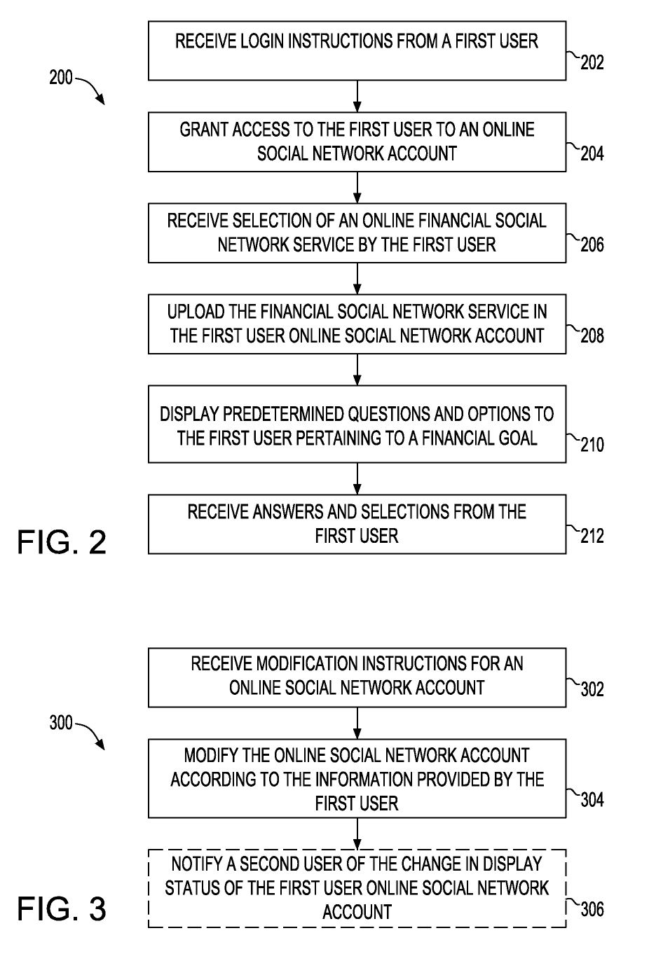

FIGS. 2-6 show flow diagrams that describe in detail an illustrative process according to the invention. FIG. 2 shows an illustrative flow diagram of a process for initiating a financial social network account. Login instructions from a first user may be received in step 202. The first user may be granted access to an online social network account in step 204. The selection of an online financial social network service by the first user may be received in step 206. The financial social network service may be uploaded to the first user online social network account in step 208. Pre-determined questions and options pertaining to a financial goal may be displayed to the first user in step 210. Answers and selections from the first user may be received in step 212.

FIG. 3 shows an illustrative flow diagram of a process for modifying an online social network account to include a financial social network account. Modification instructions for an online social network account may be received in step 302. The online social network account may be modified according to the information provided by the first user in step 304. A second user may be notified of the change in display status of the first user social network account in step 306.

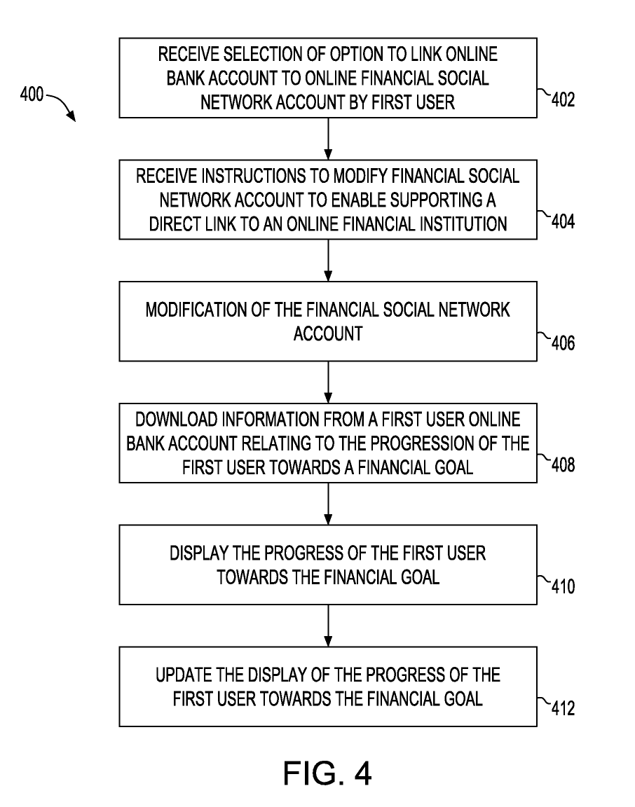

FIG. 4 shows an illustrative flow diagram of a financial social network account process. In step 402, the selection of an option to link an online bank account to an online financial social network account may be received from the first user. Instructions to modify the financial social network account to enable supporting a direct link to an online financial institution may be received in step 404. Modification of the financial social network account may occur in step 406. In step 408, information may be downloaded from a first user online bank account relating to the progression of the first user towards a financial goal. Displaying the progress of the first user towards the financial goal may occur in step 410. Updating the display of the progress of the first user towards the financial goal may occur in step 412.

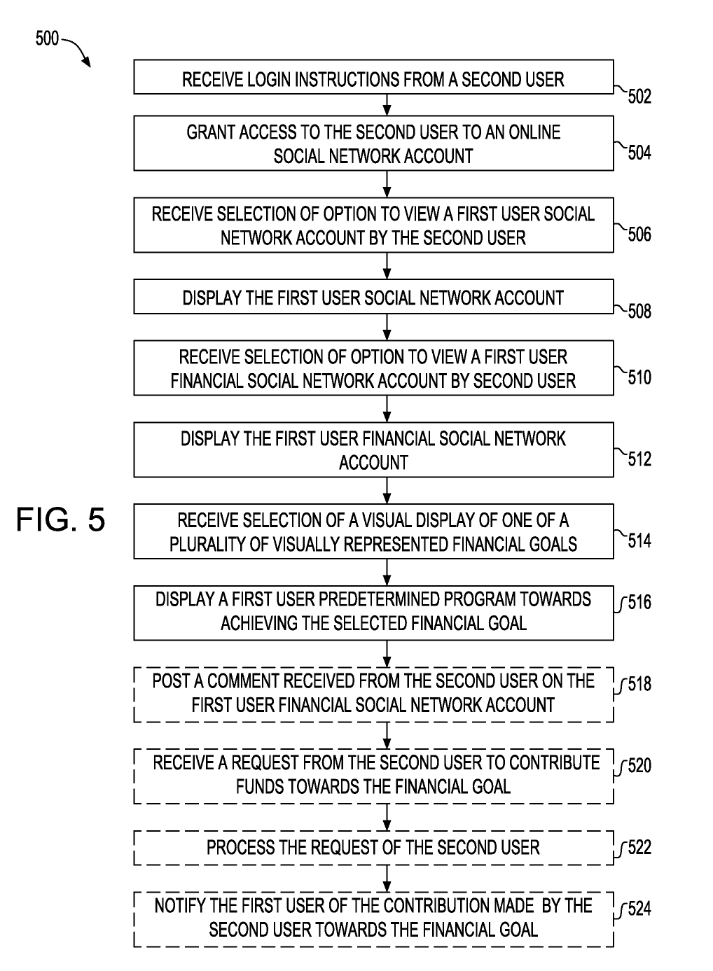

FIG. 5 shows an illustrative flow diagram of a financial social network account process. Login instructions from a second user may be received in step 502. The second user may be granted access to an online social network account in step 504. The selection of an option by the second user to view a first user social network account may be received in step 506. In step 508, the first user social network account may be displayed. In step 510, the selection of an option to view a first user financial social network account may be received. The first user financial social network account may be displayed in step 512. In step 514, the selection of a visual display of one of a plurality of visually represented financial goals may be received. A first user predetermined program towards achieving the selected financial goal may be displayed in step 516. In step 518, a comment received from the second user may be posted on the first user financial social network account. A request from the second user to contribute funds towards the financial goal may be received in step 520. The request may be processed in step 522. The first user may be notified of the contribution made by the second user towards the financial goal in step 524.

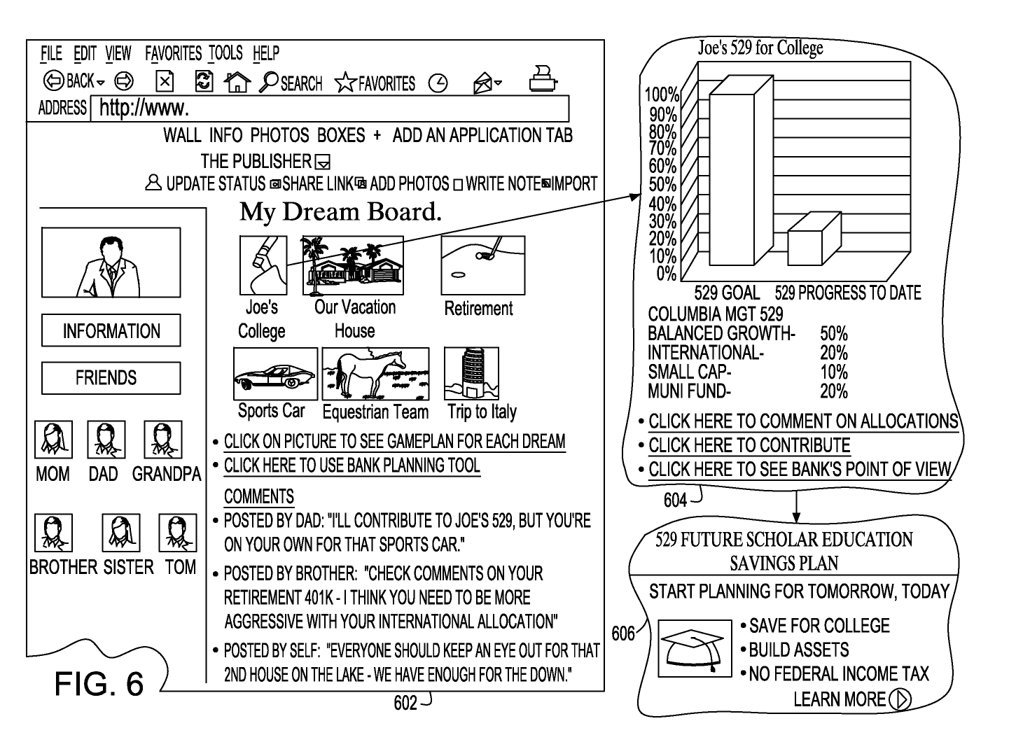

FIG. 6 shows an illustrative flow diagram of a financial social network account process. Step 602 shows a graphical user interface of an illustrative financial social network account of a first user. In step 604, selection of a visual display of a first user financial goal may display a predetermined program of the first user towards attaining the financial goal. In step 606, selection of the icon ‘CLICK HERE TO SEE BANKS'S POINT OF VIEW’ may display advice, ideas and promotions offered by a financial institution.

Thus, systems and methods for providing a financial social network account have been provided. Persons skilled in the art will appreciate that the present invention can be practiced by other than the described embodiments, which are presented for purposes of illustration rather than of limitation, and that the present invention is limited only by the claims that follow.

What is claimed is:

1. One or more computer-readable media storing computer-executable instructions which, when executed by a processor on a computer system, perform a method for providing an online financial social network account to a first user, the method using an electronic information processing platform, the method comprising:
storing in a computer memory information relating to a financial goal of a first user;
receiving instructions to change a display associated with a first user online social network account to reflect the stored financial goal information;
modifying the first user online social network account to reflect the stored financial goal information; and
authenticating a second user to access the first user online financial social network account.

2. The method of claim 1 further comprising downloading information on the one or more computer-readable media to the first user online social network account.

3. The method of claim 1 wherein the storing further comprises receiving answers to a series of questions completed by the first user pertaining to the financial goal, and storing information corresponding to the answers.

4. The method of claim 1 wherein the online financial social network account supports a direct link to a financial institution's online banking website.

5. The method of claim 1 wherein the online financial social network account supports a direct link to a first user financial institution account website.

6. The method of claim 1 wherein the modifying further comprises displaying a first user predetermined program towards achieving the financial goal.

7. The method of claim 1 wherein the modifying further comprises displaying a visual representation of the financial goal.

8. The method of claim 7 wherein the visual representation is selected by the first user from a menu of predetermined options.

9. The method of claim 7 wherein the visual representation is customizable.

10. The method of claim 7 wherein the modifying further comprises displaying the first user predetermined program towards achieving the financial goal.

11. The method of claim 1 wherein the modifying further comprises displaying the progression of the first user towards the completion of the financial goal.

12. The method of claim 11 wherein the displaying of the progression of the first user towards the financial goal is represented using representative data.

13. The method of claim 12 wherein the representative data includes percentages.

14. The method of claim 11 wherein data pertaining to the progression of the first user towards the financial goal is downloaded from a first user financial institution account.

15. The method of claim 1 wherein the modifying is followed by notifying the second user of the modified first user online social network account.

16. The method of claim 1 wherein the second user is authorized to post comments on the first user online financial social network account.

17. The method of claim 1 wherein a financial institution is authorized to display comments on the first user online financial social network account.

18. The method of claim 1 further comprising selecting an option to contribute funds towards the financial goal of the first user.

19. The method of claim 1 wherein a financial institution stores information pertaining to the financial goal of the first user.

20. The method of claim 1 wherein the first user authorizes the second user to access the first user online financial social network account.

21. The method of claim 1 further comprising transmitting an invitation to the second user to participate in the financial social network account of the first user.

22. One or more computer-readable media storing computer-executable instructions which, when executed by a processor on a computer system, perform a method for providing an online financial social network account to a first user, the method using an electronic information processing platform, the method comprising:
storing in a computer memory information relating to a financial goal of a first user;
receiving instructions to present a display reflecting the stored financial goal information; and
authenticating a second user to access the first user online financial social network account.

23. The method of claim 22 wherein the financial social network account is linked to a financial institution webpage.

24. The method of claim 22 wherein the financial social network account supports social networking capabilities.

25. The method of claim 24 further comprising receiving authorization from the first user to create a social network of friends in the first user financial social network account.

26. One or more computer-readable media storing computer-executable instructions which, when executed by a processor on a computer system, perform a method for displaying a financial goal of a first user, the method using an electronic information processing platform, the method comprising:
storing in a computer memory information relating to a financial goal of a first user;
receiving instructions to change a display associated with a first user online social network account to reflect the stored financial goal information; and
modifying the first user online social network account to reflect the stored financial goal information.
